(19) United States
(12) Patent Application Publication
(10) Pub. No.: US 2016/0123530 A1
(43) Pub. Date: May 5, 2016

(54) METHOD FOR CONTROLLING THE INTRODUCTION OF ADDITIONAL LUBRICANT INTO A BEARING LUBRICATED WITH A LUBRICANT, IN PARTICULAR A ROLLING BEARING OR PLAIN BEARING

(71) Applicant: SCHAEFFLER TECHNOLOGIES AG & CO. KG, Herzogenaurach (DE)

(72) Inventor: Michael Fassbinder, Volkach (DE)

(73) Assignee: Schaeffler Technologies AG & Co. KG, Herzogenaurach (DE)

(21) Appl. No.: 14/891,178

(22) PCT Filed: Mar. 5, 2014
(86) PCT No.: PCT/DE2014/200109

§ 371 Date: Nov. 13, 2015

(30) Foreign Application Priority Data
May 15, 2013 (DE) 10 2013 208 936.8

(51) Int. Cl. F16N 29/02; F16C 33/02; F16C 33/66

(52) U.S. Cl. CPC F16N 29/02; F16C 33/6659; F16C 33/02

(57) ABSTRACT

A method for controlling the introduction of additional lubricant (4) into a bearing (3) lubricated with a lubricant (4), in particular a rolling bearing or plain bearing, comprising the following steps is provided:—determining lubricant state information describing the state, in particular the chemical composition, of the lubricant (4) contained in the bearing (3) and—controlling the introduction of additional lubricant (4) into the bearing (3) depending on the state, which is described by the determined lubricant state information, of the lubricant (4) contained in the bearing (3).

The present invention relates to a method for controlling the introduction of additional lubricant into a bearing lubricated with a lubricant, in particular into a rolling bearing or into a sliding bearing.

### BACKGROUND

The adequate lubrication of bearings, i.e., in particular rolling or sliding bearings, with a lubricant, i.e., a lubricating grease, for example, is a fundamental requirement for their correct operation and their durability. A substantial aspect of the lubrication of corresponding bearings is relubrication, i.e., the automatic or manual introduction of additional lubricant into a bearing that is lubricated at the factory after a certain period of operation or load situation.

Typically, the introduction of additional lubricant into the bearing during relubrication is controlled in such a way that a certain or predefined quantity of additional lubricant is introduced into the bearing at a specific or predefined point in time.

The predefined lubrication intervals or predefined lubricant quantities could result in disadvantages for the operation of the bearing. This is the case, for instance, if because of a very high load, in particular thermal and/or mechanical loads, and the associated above-average degradation of the lubricant contained in the bearing, the bearing requires a more frequent introduction of additional lubricant and/or requires introducing an increased amount of lubricant, e.g., to avoid under- lubrication of the bearing. Conversely, a very low load, in particular thermal and/or mechanical loads, and the associated below-average degradation of the lubricant in the bearing, may require less frequent introduction of additional lubricant and/or a reduced quantity of lubricant to be introduced, e.g., to avoid over-lubrication of the bearing.

### SUMMARY OF THE INVENTION

It is an object of the present invention to provide a method for controlling the introduction of additional lubricant into a bearing lubricated with a lubricant, in particular into a rolling bearing or into a sliding bearing.

The present invention provides a method for controlling the introduction of additional lubricant into a bearing lubricated with a lubricant, in particular into a rolling bearing or into a sliding bearing, including the following steps: ascertaining lubricant status information describing the status, in particular the chemical composition of the lubricant contained in the bearing and controlling the introduction of additional lubricant into the bearing as a function of the status, described by the ascertained lubricant status information, of the lubricant contained in the bearing.

The present invention provides a special method for controlling the introduction of additional lubricant, in particular lubricating grease, into a bearing lubricated with a lubricant. The introduction of additional lubricant into the bearing lubricated with a lubricant may also be understood as relubricating the bearing. Therefore, according to the present invention, a special technical approach is proposed for controlling the relubrication of a bearing lubricated with a lubricant.

The method according to the present invention is directed at testing or checking the status of the lubricant presently contained in the bearing prior to the introduction of additional lubricant into a corresponding bearing. In this context, in a first step of the method according to the present invention, lubricant status information is ascertained which describes the status, in particular the chemical composition of the lubricant contained in the bearing. The lubricant status information may be ascertained in-situ, i.e., during operation of the bearing. There is no need to remove lubricant from the bearing, which generally requires interrupting the bearing operation.

The lubricant status information therefore describes one or multiple lubricant parameters that qualitatively or quantitatively describe the status of the lubricant presently contained in the bearing. In particular, the lubricant status information indirectly or directly describes the chemical composition of the lubricant presently contained in the bearing. The chemical composition of the lubricant described by the lubricant status information typically allows conclusions to be drawn regarding the properties or quality of the lubricant. In particular, conclusions may be drawn regarding the present status, i.e., in particular the lubricant's degradation status, aided by information regarding the proportional chemical composition of the lubricant and therefore the presence of certain chemical substances, which are generally to be understood as chemical compounds within the lubricant, chemical or functional groups of the substances forming the lubricant, etc.

As a function of the present status of the lubricant contained in the bearing, it is optionally also possible to make statements about further changes, i.e., future changes, of the lubricant's status which are to be expected. In this process, it may be advantageous to take into account lubricant-specific influential factors such as atmosphere, temperature, and/or the bearing's present or expected future operating conditions.

Based upon the ascertained lubricant status information or the present status of the lubricant contained in the bearing described by these factors, the additional lubricant may be optionally introduced into the bearing as needed in a second step of the method according to the present invention. The introduction of additional lubricant into the bearing, which corresponds to the relubrication of the bearing, is therefore carried out as a function of the present status of the lubricant contained in the bearing as described by the lubricant status information.

According to the present invention, as a function of the lubricant status described by the lubricant status information, generally an initial decision is made as to whether or not additional lubrication or relubrication of the bearing is required. An essential deciding criterion for introducing additional lubricant into the bearing is therefore the status of the lubricant presently contained in the bearing. Other parameters which are not related to the status of the lubricant, in particular parameters concerning the operating conditions of the bearing, need not be taken into account according to the present invention.

This creates a significant difference as compared to the known procedures for relubricating such bearings, since according to the present invention, relubrication is no longer carried out at predefined points in time with a predefined quantity of lubricant, but is instead carried out individually as a function of the present status of the lubricant contained in the bearing. This therefore precludes any over- or under-lubrication of the bearing.

Provided that the lubricant status information indicates a change, i.e., in particular degradation, in the status of the lubricant presently contained in the bearing, which is detectable by a proportional increase in the concentration or degradation of the (or a) chemical substance forming the lubricant, relubrication of the bearing is carried out as needed, i.e., an adequate quantity of additional lubricant is introduced into the bearing. Not only is it possible to advantageously determine the additional lubricant quantity which needs to be introduced into the bearing based upon the lubricant status information, it is also possible to advantageously determine the manner in which the additional lubricant must be introduced, i.e., the time period over which this is to occur. For example, the additional lubricant quantity to be introduced into the bearing may be introduced into the bearing once at a specific point in time, continuously spread over a specific time period, or discontinuously, portioned out over multiple points in time.

In one specific embodiment of the method according to the present invention, it is therefore possible that within the scope of controlling the introduction of additional lubricant into the bearing, lubrication intervals are established or the bearing's predefined lubrication intervals will be changed. Thus, as a function of the lubricant status information, not only will a decision be made in principle as to whether an additional lubrication or relubrication is required or must be carried out, but also at what points in time or over what time period the additional lubrication of the bearing is to occur. A significantly worsened condition of the lubricant contained in the bearing as compared to the original or a previously ascertained status, i.e., a highly degraded lubricant, typically requires more frequent introduction of additional lubricant. Conversely, a slightly worsened condition of the lubricant contained in the bearing as compared to the original or a previously ascertained status, i.e., a slightly degraded lubricant, typically requires less frequent introduction of additional lubricant.

In particular, it is also possible within the scope of the method according to the present invention to influence a predefined control for introducing additional lubricant into a lubricated bearing. For example, as a function of the status of the lubricant presently contained in the bearing, predefined lubrication intervals may be changed, i.e., extended or shortened, and therefore adapted to the status of the lubricant.

In a further specific embodiment of the method according to the present invention, it is also possible that within the scope of controlling the introduction of additional lubricant into the bearing, an additional lubricant quantity to be introduced into the bearing is established or a predefined lubricant quantity to be introduced into the bearing is changed. The additional lubricant quantity to be introduced into the bearing is therefore also established advantageously as needed, i.e., adapted to the status of the lubricant presently contained in the bearing. A significantly worsened condition of the lubricant contained in the bearing as compared to the original or a previously ascertained status, i.e., a highly degraded lubricant, typically requires a comparatively large additional lubricant quantity to be introduced. Conversely, a status of the lubricant which is only slightly degraded compared to the original or previous status of the lubricant contained in the bearing which was ascertained, i.e., a slightly degraded lubricant, typically requires a comparatively small lubricant quantity to be additionally introduced.

As discussed with respect to the influence of predefined lubrication intervals, the method according to the present invention also makes it possible in particular to change, i.e., increase or reduce, a predefined lubricant quantity to be additionally introduced into the bearing, and therefore to adapt it to the status of the lubricant which is presently contained in the bearing.

The lubricant status information is ascertained in particular by means of spectroscopic analysis, in particular infrared spectroscopic analysis, of the lubricant contained in the bearing. The lubricant status information is therefore ascertained based on spectroscopic, in particular infrared spectroscopic, measurements or analyses of the lubricant. At this juncture, it is possible to measure spectra of the electromagnetic radiation emitted from the lubricant, for example after emission of electromagnetic radiation of a specific wavelength range. The analysis of the spectra provides information regarding the chemical status of the lubricant. In particular, the measured spectra provide information regarding the chemical composition of the lubricant. This information is preferably largely independent of foreign objects that may be contained in the lubricant, e.g., due to bearing wear. For the spectroscopic analyses of the lubricant carried out within the scope of ascertaining the lubricant status information, typically a transmitter for the emission of electromagnetic radiation, in particular infrared radiation, onto the lubricant contained in the bearing, a receiver for receiving the electromagnetic radiation emitted by the lubricant, in particular reflected electromagnetic radiation, in particular infrared radiation, as well as a control or evaluation unit connected with these are used.

Within the scope of the spectroscopic analyses of the lubricant contained in the bearing, a reflection, in particular a total reflection, of the electromagnetic radiation, in particular infrared radiation, emitted from a transmitter may be measured. The information regarding the lubricant's chemical composition may be ascertained here from the measured reflection spectrum.

The use of infrared spectroscopic analyses of the lubricant contained in the bearing for ascertaining the lubricant status information has a number of advantages. By measuring the infrared radiation, in particular the medium or near infrared radiation emitted by the lubricant, precise information regarding the lubricant's chemical composition may be obtained. This is based upon the fact that the infrared radiation stimulates chemical compounds such as molecules, molecule groups, etc., in the lubricant, this stimulation being infrared spectroscopically measurable, and consequently provides precise information regarding the lubricant's chemical condition, i.e., in particular the lubricant's infrared-active chemical constituents. Based upon infrared spectroscopic analyses of the lubricant, it is also possible to obtain immediate information regarding the chemical composition of the lubricant contained in the bearing. An additional advantage of infrared spectroscopic analyses is that infrared radiation typically does not negatively change or influence the lubricant's chemical composition.

In principle it is advantageous to ascertain the lubricant status information continuously, i.e., permanently without interruption, in order to obtain preferably comprehensive knowledge regarding the status or changes in the status of the lubricant contained in the bearing. It is also conceivable, however, to ascertain the lubricant status information only at specified points in time or at specified time intervals, e.g., every 10 seconds.

In refining the present invention it may be advantageously provided that the additional quantity of lubricant is introduced only if the status of the lubricant as described by the lubricant status information reaches at least one predefined or predefinable lubricant-specific lubricant status limiting value, in particular exceeds it or drops below it. Consequently, a lubricant-specific lubricant status limiting value is present or will be predefined in this specific embodiment of the method according to the present invention, the reaching of which indicates that relubrication of the bearing is required. Therefore, when the lubricant status limiting value is reached, a situation generally exists in which the status of the lubricant has degraded in such a way that the lubricant is typically degraded to such an extent that the introduction of additional lubricant is in order. The lubricant status limiting value is lubricant-specific, i.e., it is typically defined as a function of the original chemical composition of the lubricant actually contained in the bearing. If the comparison of the ascertained lubricant status information with the lubricant status limiting value shows that the former has reached, or exceeded or dropped below the lubricant status limiting value, additional lubricant is introduced into the bearing.

The lubricant status limiting value may be, for example, the concentration of a specific chemical compound, functional group, etc., which is characteristic for the non-degraded status of the lubricant. Its original concentration in the lubricant may be assumed or established to be 100%. The corresponding lubricant status limiting value based upon such a chemical compound, functional group, etc. may be 80%, for example.

The lubricant status limiting value may also be the concentration of a characteristic chemical compound, functional group, etc., which indicates a degradation of the lubricant. Its original concentration in the lubricant may be assumed or established to be 0%. The corresponding lubricant status limiting value based upon such a chemical compound, functional group, etc. may be 30%, for example.

The present invention further relates to a device for the introduction of additional lubricant into a bearing lubricated with a lubricant, in particular into a rolling bearing or into a sliding bearing. The device includes at least one control unit designed for ascertaining lubricant status information describing the status of the lubricant contained in the bearing and for controlling the introduction of a specific quantity of additional lubricant into the bearing, as a function of the status of the lubricant contained in the bearing described by the ascertained lubricant status information.

The control unit may communicate with a lubricant reservoir assigned to the bearing to be lubricated and/or with a lubricant conveying system assigned to the bearing to be lubricated, in particular in the form of a pump unit.

In principle, all embodiments regarding the method according to the present invention are applicable to the device according to the present invention, since the device according to the present invention is designed in particular for carrying out the method according to the present invention.

### BRIEF DESCRIPTION OF THE DRAWINGS

One exemplary embodiment of the present invention is illustrated in the drawings and described in greater detail below.

FIG. 1 shows a block diagram for illustrating a method according to an exemplary specific embodiment of the present invention; and

FIG. 2 shows a device for carrying out a method according to an exemplary specific embodiment of the present invention.

### DETAILED DESCRIPTION

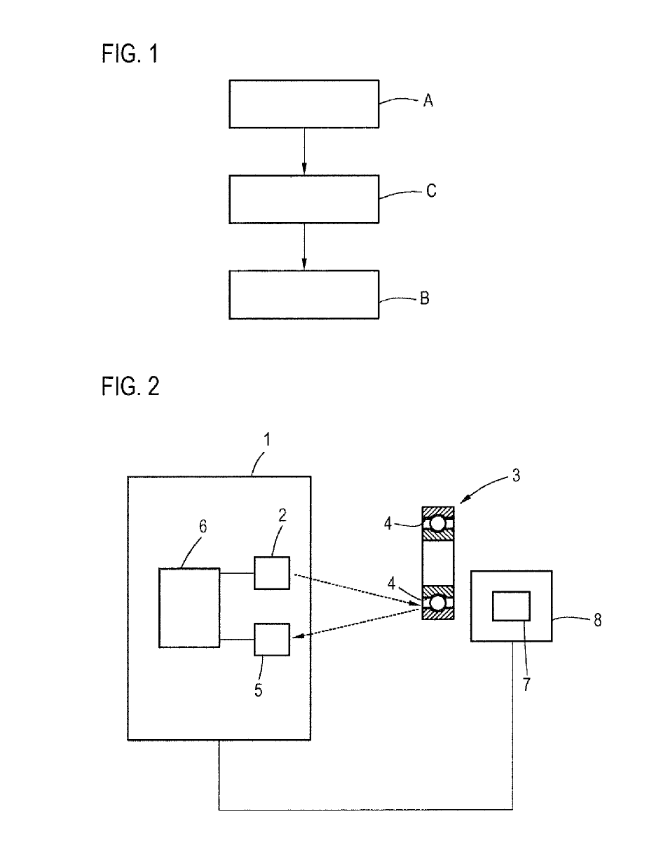

FIG. 1 shows a block diagram for illustrating a method according to an exemplary specific embodiment of the present invention. The method is intended to control the introduction of additional lubricant 4 into a bearing 3 lubricated with a lubricant 4 (see FIG. 2). The introduction of additional lubricant 4 into bearing 3 lubricated with lubricant 4 corresponds to a relubrication of bearing 3. Lubricant 4 may be a lubricating grease or a lubricating oil, for example. Bearing 3 may be a sliding or rolling bearing, for example.

In a first step of the method indicated by box A, lubricant status information is ascertained which describes the status, i.e., in particular the chemical composition of lubricant 4 contained in bearing 3. The preferably continuous, i.e., permanent ascertainment of the lubricant status information is carried out using spectroscopic, in particular infrared spectroscopic measurements or analyses of lubricant 4 contained in the bearing, from which conclusions may be drawn regarding the chemical composition of lubricant 4. Characteristic chemical molecules and/or characteristic chemical functional groups may be identified in this way, for example.

As is evident from FIG. 2, a corresponding device 1 for carrying out the method includes a transmitter 2, via which infrared radiation, i.e., electromagnetic radiation, with a wavelength in the range between 780 nm and 1 mm, is radiated onto lubricant 4 contained in bearing 3, in particular in the area of respective rolling element tracks, during the operation of bearing 3, which is indicated here as a rolling bearing.

The device 1 also includes a receiver 5, which receives the electromagnetic radiation, in particular infrared radiation, reflected by lubricant 4. Via a control and evaluation unit 6, which is also part of device 1 and which communicates with transmitter 2 as well as with receiver 5, it is possible to infer the chemical composition of lubricant 4 and to ascertain corresponding lubricant status information. The lubricant status information may be output via a display unit (not illustrated in detail) assigned to device 1.

Referring again to the block diagram illustrated in FIG. 1, in a second step of the method indicated by box B, as a function of the ascertained lubricant status information or as a result of the status of lubricant 4 contained in bearing 3, a decision is made as to whether or not a relubrication of bearing 3, i.e., the introduction of additional lubricant 4 into bearing 3, is carried out.

The relubrication of bearing 3 is therefore carried out solely as a function of the present status of lubricant 4 contained in this bearing. Contrary to the known approaches for relubrication of bearings known from the prior art, which typically provide for introducing a predefined lubricant quantity into the bearing at predefined points in time, according to the present invention the relubrication of bearing 3 is carried out on an individualized basis, i.e., depending upon demand and appropriate to requirements, in terms of the present status of the lubricant.

In this way, it is possible to prevent both over-lubrication of bearing 3, which results in particular in an increased load on bearing 3, in particular due to increased churning work, as well as under-lubrication of bearing 3, which results in particular in an increased load on bearing 3, in particular due to increased wear.

When deciding whether additional lubricant 4 should be introduced into bearing 3, a comparison of the ascertained lubricant status information with a lubricant status limiting value stored, for example, in a data memory (not shown in detail) of device 1 is preferably taken into account (see box C). The ascertained lubricant status information may therefore be compared with lubricant status limiting value. If the comparison of the lubricant status information with the lubricant status limiting value shows that the status described by the lubricant status information has reached the lubricant status limiting value or has exceeded or dropped below it, additional lubricant 4 is introduced into bearing 3 or a relubrication of bearing 3 takes place. For this purpose, device 1 activates, for example, a lubricant conveying system 8, connected to a lubricant reservoir 7, for example, in the form of a pump unit, which introduces a specific lubricant quantity into bearing 3 at a defined point in time or over a defined time period.

The lubricant status limiting value may be, for example, the concentration of a specific chemical compound, functional group, etc., which is characteristic for the non-degraded status of the lubricant. Its original concentration in the lubricant may be assumed or established to be 100%. A corresponding lubricant status limiting value based upon such a chemical compound, functional group, etc. may be 80%, for example. The lubricant status limiting value may also be a characteristic chemical compound, functional group, etc., which indicates a degradation of the lubricant. Its original concentration in the lubricant may assumed or established to be 0%. A corresponding lubricant status limiting value based upon such a chemical compound, functional group, etc. may be 30%, for example.

In this context, it is conceivable that the control for introducing additional lubricant 4 into bearing 3 correlates or influences a predefined control for introducing additional lubricant 4 into bearing 3, in which predefined lubrication intervals of bearing 3 and/or a predefined lubricant quantity during lubrication of bearing 3 is/are defined. Predefined lubrication intervals may consequently be extended or shortened, as a function of the ascertained lubricant status information, for example. Similarly, it is possible to change a previously established lubricant quantity, i.e., it may be increased or decreased. In this way, over- or under-lubrication of bearing 3 may be prevented.

In the context of the lubricant reservoir 7, it may be provided that device 1 detects a specific lubricant fill status value contained within it in terms of a residual lubricant quantity contained in the lubricant reservoir, and outputs a message when it reaches or falls below this value.

### LIST OF REFERENCE NUMERALS

1 Device
2 Transmitter
3 Bearing
4 Lubricant
5 Receiver
6 Control and/or evaluation unit
7 Lubricant reservoir
8 Lubricant conveying system

What is claimed is:

1-9. (canceled)

10. A method for controlling introduction of additional lubricant into a bearing lubricated with a lubricant, comprising the following steps:
ascertaining lubricant status information describing a status of the lubricant contained in the bearing; and
controlling the introduction of the additional lubricant into the bearing as a function of the state of the lubricant contained in the bearing described by the ascertained lubricant status information.

11. The method as recited in claim 10 wherein lubrication intervals are established or predefined lubrication intervals of the bearing are changed within the scope of the control.

12. The method as recited in claim 10 wherein the controlling includes establishing an additional lubricant quantity to be introduced into the bearing or changing a predefined additional lubricant quantity to be introduced into the bearing.

13. The method as recited in claim 10 wherein the lubricant status information is ascertained via spectroscopic analyses of the lubricant.

14. The method as recited in claim 10 wherein the spectroscopic analyses include infrared spectroscopic analyses of the lubricant.

15. The method as recited in claim 10 wherein the lubricant status information indirectly or directly describes a chemical composition of the lubricant.

16. The method as recited in claim 10 wherein the lubricant status information is ascertained continuously.

17. The method as recited in claim 10 wherein the lubricant status information is ascertained discontinuously at specific points in time.

18. The method as recited in claim 10 wherein the introduction of the additional quantity of lubricant takes place only if the status of the lubricant described by the lubricant status information reaches at least one predefined, lubricant-specific lubricant status limiting value, in particular exceeds it or drops below it.

19. The method as recited in claim 18 wherein the introduction of the additional quantity of lubricant takes place only if the status of the lubricant described by the lubricant status information exceeds the at least one predefined, lubricant-specific lubricant status limiting value.

20. The method as recited in claim 18 wherein the introduction of the additional quantity of lubricant takes place only if the status of the lubricant described by the lubricant status information drops below the at least one predefined, lubricant-specific lubricant status limiting value.

21. The method as recited in claim 10 wherein the bearing is a rolling bearing or sliding bearings.

22. A device for introducing additional lubricant into a bearing lubricated with a lubricant comprising:
at least one controller designed for ascertaining lubricant status information describing the status of the lubricant contained in the bearing as well as for controlling the introduction of a specific quantity of additional lubricant into the bearing as a function of the status of the lubricant contained in the bearing described by the ascertained lubricant status information.

23. The device as recited in claim 22 wherein the bearing is a rolling or sliding bearing.

24. A device for introducing additional lubricant into a bearing lubricated with a lubricant according to the method as recited in claim 10, the device comprising:
at least one controller designed for ascertaining lubricant status information describing the status of the lubricant contained in the bearing as well as for controlling the introduction of a specific quantity of additional lubricant into the bearing as a function of the status of the lubricant contained in the bearing described by the ascertained lubricant status information.
